(19) United States
(12) Patent Application Publication
(10) Pub. No.: US 2007/0143726 A1
(43) Pub. Date: Jun. 21, 2007

(54) Circuit design apparatus, circuit design program, and circuit design method

(75) Inventors: Ryo Mizutani, Kawasaki (JP); Seiji Shigihara, Kawasaki (JP); Hiromichi Makishima, Kawasaki (JP); Yasutomo Honma, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/384,344

(22) Filed: Mar. 21, 2006

(30) Foreign Application Priority Data
Dec. 15, 2005 (JP) 2005-361877

(51) Int. Cl. G06F 17/50

(52) U.S. Cl. 716/11

(57) ABSTRACT

There is provided a circuit design apparatus that performs logic design for realizing a reduction of power consumption and circuit simplification.

A circuit design apparatus interprets RTL of a design target to perform structure analysis thereof (S2), estimates generation of a clock gating based on a result of the structure analysis, detects RTL description of an EN generation logic (S3), and detects the same EN generation logic (S4). The apparatus determines an insertion location of the clock gating circuit and reorganization of logical hierarchies based on the detected EN generation logic (S5), instructs logical hierarchy reorganization to be performed in logic synthesis (S8) and performs design change processing (S6). The apparatus performs logic synthesis based on RTL after design change and instruction of logical hierarchy reorganization (S10), and layouts a concrete circuit configuration (S12).

### BACKGROUND OF THE INVENTION

1. Field of the Invention

The present invention relates to a circuit design apparatus that performs logic circuit design and, more particularly, to a circuit design apparatus, a circuit design program, and a circuit design method that perform logic design for realizing a reduction of power consumption of a circuit.

2. Description of the Related Art

A reduction of power consumption is required in a large-scale LSI (Large Scale Integrated circuit) and, in order to realize it, various optimizations have been made. As a method for realizing such optimization, a circuit design apparatus and circuit design method that perform a circuit design so that power consumption is reduced in LSI logic design are widely known. For example, in the case where an LSI logic circuit is described in HDL (Hardware Description Language, the HDL is written so that a clock gating circuit (clock buffer with gating logic) is incorporated to thereby reduce power consumption.

FIGS. 3A to 3C are conceptual views each showing a circuit configuration for realizing a reduction of power consumption of an LSI in a conventional circuit design apparatus. FIG. 3A shows a logic configuration at logic design stage described in HDL, FIG. 3B shows a circuit configuration after logic synthesis, and FIG. 3C shows a circuit configuration after layout.

As shown in FIG. 3A, the HDL at the logic design stage of a logic configuration is written so that a common clock signal is distributed to flip-flop circuits 12a and 13a of respective logical hierarchies 12 and 13 from a clock generator 11a of a logic circuit 11. Similarly, the HDL is written so that an enable signal (control signal) from enable (EN) generation logic 11b of the logic circuit 11 is distributed to the flip-flop circuits 12a and 13a of the logical hierarchies 12 and 13.

At this time, according to the HDL, while the clock signal from the clock generator 11a is constantly supplied to the respective logical hierarchies 12 and 13, the enable signal (control signal) from the EN generation logic 11b is enabled in sync with the operation timing of the flip-flop circuits 12a and 13a included the respective logical hierarchies 12 and 13.

The logic configuration at the logic design stage (FIG. 3A) becomes a circuit configuration after logic synthesis (FIG. 3B) through logic synthesis. More specifically, as shown in FIG. 3B, the logical hierarchies 12 and 13 are mapped to respective clock gating circuits 12c, 13c and respective flip-flop circuits 12d, 13d to which an enable signal (control signal) is not provided to obtain a circuit configuration. In this case, which of the flip-flop circuits the clock gating circuits 12c and 13c are generated in depends upon the function of a logic synthesis tool. In most cases, the clock gating circuit is generated in the same logical hierarchy as that of the flip-flop circuit.

After the circuit configuration after logic synthesis (FIG. 3B) has been realized, the clock gating circuits 12c and 13c open/close gates in sync with the operation timing of the flip-flip circuits 12d and 13d of the logical hierarchies 12 and 13. That is, the gates are opened/closed so that a clock signal is supplied only to the flip-flop circuit to be activated according to the enable signal (control signal) from the EN generation logic 11b of the logic circuit 11. Accordingly, a clock signal is not supplied to a flip-flop circuit corresponding to a clock gating circuit of the logical hierarchy in which the gate is closed, thereby reducing power consumption of the relevant flip-flop circuit.

Further, after the circuit configuration after logic synthesis (FIG. 3B) has been realized, the circuit configuration is laid out. The locations of the clock gating circuits 12c and 13c depend respectively on the location of the flip-flop circuits 12d and 13d. This arrangement extends the wiring distance between the clock generator 11a and respective clock gating circuits 12c and 13c. Therefore, as shown in FIG. 3C which shows a circuit configuration after layout, buffer circuits 11c, 12e, and 13e are inserted between the clock generator 11a and respective clock gating circuits 12c and 13c. As described above, the circuit configuration after layout (FIG. 3C) allows reduction of power consumption.

As a prior art related to the present invention, Jpn. Pat. Appln. Laid-Open Publication No. 2003-330988 (paragraphs 0016 to 0019 and 0030, FIG. 1) is known. According to this technique, an automatic insertion of a gated-clock supply circuit in a hardware description allows improvement of efficiency in design work of a logic circuit and reduction of power consumption of a logic circuit.

However, although various logic synthesis tools that perform logic design for optimization allowing a reduction of power consumption in a large-scaled LSI circuit have been reported, there are various constraints in the circuit optimization using the logic synthesis tool. For example, it is impossible to perform circuit optimization across a plurality of logical hierarchies, or there is a certain limit in HDL description in logic design.

More concretely, as shown in FIG. 3C, a clock gating circuit is inserted for each logical hierarchy and each flip-flop circuit, inevitably increasing the number of clock gating circuits. This prevents further reduction of power consumption. Further, a clock gating circuit exists for each logical hierarchy and each flip-flop circuit, inevitably extending each signal line. Accordingly, a wave-shaping buffer becomes necessary for each logical hierarchy, resulting in an increase in circuit scale to thereby increase power consumption.

### SUMMARY OF THE INVENTION

The present invention has been made to solve the above problems, and an object thereof is to provide a circuit design apparatus, a circuit design program, and a circuit design method that perform logic design for realizing a reduction of power consumption and circuit simplification.

To solve the above problem, according to a first aspect of the present invention, there is provided a circuit design apparatus that makes correction of circuit design data for use in performing circuit design using logic synthesis, comprising: a generation circuit data detection section that detects, based on the circuit design data, a first data portion in which a first clock gating circuit is estimated to be generated and a second data portion in which a control circuit that controls the first clock gating circuit is estimated to be generated; a logical hierarchy detection section that detects logical hierarchies of the first clock gating circuit and the control circuit, generations of which are estimated by the generation circuit data detection section; and a circuit design data correction instruction section that instructs reorganization of logical hierarchies in the circuit design data so that the number of logical hierarchies of the first clock gating circuit detected by the logical hierarchy detection section is reduced.

Further, in the circuit design apparatus according to the present invention, the circuit design data correction instruction section instructs insertion of a second clock gating circuit in the same logical hierarchy as the control circuit whose generation is estimated by the generation circuit data detection section.

Further, in the circuit design apparatus according to the present invention, in the case where a plurality of first clock gating circuits controlled by one control circuit whose generation is estimated by the generation circuit data detection section are estimated to be generated in a plurality of logical hierarchies, the circuit design data correction instruction section instructs correction of the circuit design data so that the plurality of logical hierarchies are developed.

Further, the circuit design apparatus according to the present invention further comprises a circuit design data correction section that performs reorganization of logical hierarchies and insertion of the second clock gating circuit for the circuit design data based on an instruction from the circuit design data correction instruction section.

Further, the circuit design apparatus according to the present invention further comprises a logic synthesis section that performs logic synthesis of circuit design data corrected by the circuit design data correction section.

To solve the above problem, according to a second aspect of the present invention, there is provided a circuit design program allowing a computer to make correction of circuit design data for use in performing circuit design using logic synthesis, the program allowing the computer to execute: a generation circuit data detection step that detects, based on the circuit design data, a first data portion in which a first clock gating circuit is estimated to be generated and a second data portion in which a control circuit that controls the first clock gating circuit is estimated to be generated; a logical hierarchy detection step that detects logical hierarchies of the first clock gating circuit and the control circuit, generations of which are estimated by the generation circuit data detection step; and a circuit design data correction instruction step that instructs reorganization of logical hierarchies in the circuit design data so that the number of logical hierarchies of the first clock gating circuit detected by the logical hierarchy detection step is reduced.

Further, in the circuit design program according to the present invention, the circuit design data correction instruction step instructs insertion of a second clock gating circuit in the same logical hierarchy as the control circuit whose generation is estimated by the generation circuit data detection step.

Further, in the circuit design program according to the present invention, in the case where a plurality of first clock gating circuits controlled by one control circuit whose generation is estimated by the generation circuit data detection step are estimated to be generated in a plurality of logical hierarchies, the circuit design data correction instruction step instructs correction of the circuit design data so that the plurality of logical hierarchies are developed.

Further, the circuit design program according to the present invention, further allows the computer to execute, after the circuit design data correction instruction step, a circuit design data correction step that performs reorganization of logical hierarchies and insertion of the second clock gating circuit for the circuit design data based on an instruction from the circuit design data correction instruction step.

Further, the circuit design program according to the present invention, further allows the computer to execute, after the circuit design data correction step, a logic synthesis step that performs logic synthesis of circuit design data corrected by the circuit design data correction step.

To solve the above problem, according to a third aspect of the present invention, there is provided a circuit design method that makes correction of circuit design data for use in performing circuit design using logic synthesis, comprising: a generation circuit data detection step that detects, based on the circuit design data, a first data portion in which a first clock gating circuit is estimated to be generated and a second data portion in which a control circuit that controls the first clock gating circuit is estimated to be generated; a logical hierarchy detection step that detects logical hierarchies of the first clock gating circuit and the control circuit, generations of which are estimated by the generation circuit data detection step; and a circuit design data correction instruction step that instructs reorganization of logical hierarchies in the circuit design data so that the number of logical hierarchies of the first clock gating circuit detected by the logical hierarchy detection step is reduced.

According to the present invention, logic design in which the clock gating circuit is adequately inserted allows a reduction of power consumption and circuit simplification.

### BRIEF DESCRIPTION OF THE DRAWINGS

FIGS. 1A to 1D are conceptual views each showing a circuit configuration for realizing a reduction of power consumption of an LSI in a circuit design apparatus according to the present invention;

FIG. 2 is a flowchart showing the design flow of the circuit design apparatus for LSI to which the present invention is applied; and

FIGS. 3A to 3C are conceptual views each showing a circuit configuration for realizing a reduction of power consumption of an LSI in a conventional circuit design apparatus.

### DETAILED DESCRIPTION OF THE PREFERRED EMBODIMENTS

An embodiment of a circuit design apparatus according to the present invention will be described below in detail with reference to the accompanying drawings. Firstly, an overview of the circuit design apparatus according to the present invention will be given.

A circuit design apparatus according to the present invention is used to perform, for example, low power consumption design for an LSI. Firstly, in the circuit design apparatus, RTL (Register Transfer Level) of a design target is input. Then clock gating circuits that will be generated after logic synthesis are estimated based on structure analysis performed by the circuit design apparatus. At the same time, identical enable (EN) generation logic is detected.

Then, an optimal insertion location of the clock gating circuit is determined based on the detected EN generation logic and, at the same time, logical hierarchies to be developed are determined. Further, a design change instruction including insertion of the clock gating circuit and reorganization of logical hierarchies is output as design change information and, at the same time, an instruction (command) of reorganization of logical hierarchies for logical synthesis tool is output as a logical hierarchy reorganization instruction card. With the above configuration, both a reduction of power consumption of an LSI and simplification of a circuit can be realized.

Further, when design change including insertion of the clock gating circuits or reorganization of logical hierarchies is executed based on the above design change information and logical hierarchy reorganization instruction card, logical synthesis and layout processing can effectively be carried out.

Note that the development of the logical hierarchies may lead to a problem of increased processing time for logical synthesis. Thus, in order to avoid this, the reorganization of the logical hierarchies may be performed by developing or creating the logical hierarchies on a per function basis.

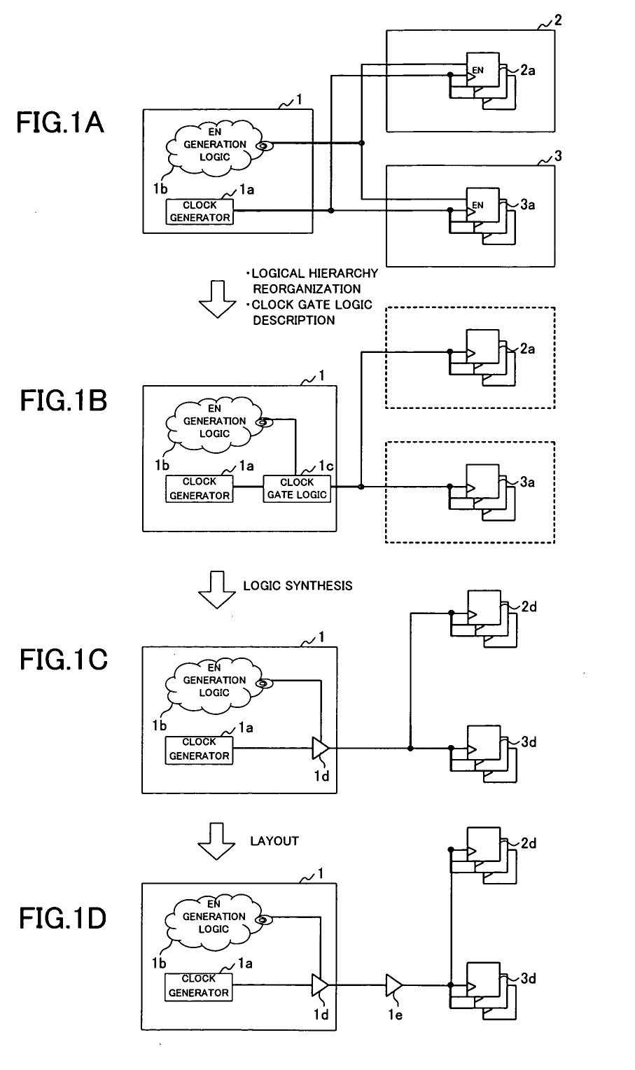

Hereinafter, a preferred embodiment of a circuit design apparatus according to the present invention will be described, taking a circuit design apparatus that performs low power consumption design for an LSI as an example. FIGS. 1A to 1D are conceptual views each showing a circuit configuration for realizing a reduction of power consumption of an LSI in the circuit design apparatus according to the present invention. FIG. 1A shows a logic configuration at logic design stage of RTL of a design target, the RTL being described in HDL, FIG. 1B shows a circuit configuration after logic design change, in which clock gate logic description and logical hierarchy reorganization have been made by the circuit design apparatus, FIG. 1C shows a circuit configuration after logic synthesis, and FIG. 1D shows a circuit configuration after layout.

As shown in FIG. 1A, RTL of a design target at the logic design stage is written so that a common clock signal is distributed from a clock generator 1a of a logic circuit 1 to flip-flop circuits 2a and 3a of logical hierarchies 2 and 3. Similarly, the RTL is written so that an enable signal (control signal) from an enable (EN) generation logic 1b of the logic circuit 1 is distributed to the flip-flop circuits 2a and 3a of the logical hierarchies 2 and 3.

At this time, according to the RTL, while the clock signal from the clock generator 1a is constantly supplied to the respective logical hierarchies 2 and 3, the enable signal (control signal) from the EN generation logic 1b is enabled in sync with the operation timing of the flip-flop circuits 2a and 3a included the respective logical hierarchies 2 and 3.

Then, insertion of the clock gate logic and reorganization of logical hierarchies are performed by the circuit design apparatus to obtain a logic configuration after logic design change (FIG. 1B) in which the insertion of the clock gate logic and reorganization of logical hierarchies have been made. That is, as shown in FIG. 1B, when a clock gate logic 1c is additionally inserted to a common line connected between the output side of the clock generator 1a and output side of the enable (EN) generation logic 1b in the logic circuit 1, the insertion location of the clock gating circuit is determined. Further, the logical hierarchies 2 and 3 as shown in FIG. 1A are developed and the logical hierarchies to which the flip-flop circuits 2a and 3a belong to are deleted. That is, RTL of a design target after logic design change assumes a logic configuration as shown in FIG. 1B.

Further, the circuit design apparatus performs logic synthesis for the logic configuration after design change (FIG. 1B) to apply mapping. A circuit configuration after logic synthesis is as shown in FIG. 1C. More specifically, through a process of reducing power consumption in the logic synthesis, a clock gating circuit 1d is inserted to a common line connected between the output side of the clock generator 1a and output side of the enable (EN) generation logic 1b in the logic circuit 1. Further, flip-flop circuits 2d and 3d are mapped on a circuit configuration so that they are connected in common to the output line of the clock gating circuit 1d after the logical hierarchies thereof has been removed. At this time, the flip-flop circuits 2d and 3d are both connected to the output side of the clock gating circuit 1d and, naturally, an enable signal (control signal) is not provided to the flip-flop circuits 2d and 3d.

After the circuit configuration after logic synthesis (FIG. 1C) has been realized, the clock gating circuit 1d opens/closes a gate in sync with the operation timing of the flip-flip circuits 2d and 3d according to the enable signal (control signal) from the enable (EN) generation logic 1b. That is, the gate is opened/closed so that a clock signal is supplied only to the flip-flop circuit to be activated according to the enable signal (control signal) from the EN generation logic 1b of the logic circuit 1. Accordingly, a clock signal is not supplied to a flip-flop circuit corresponding to a closed gate of the clock gating circuit, thereby reducing power consumption of the relevant flip-flop circuit. Further, the number of clock gating circuits is reduced to one, allowing a further reduction of power consumption and circuit simplification.

Further, after the circuit configuration after logic synthesis (FIG. 1C) has been realized, the circuit configuration is laid out. The location of the clock gating circuit 1d shared between the flip-flop circuits 2d and 3d depends on the location of the flip-flop circuits 2d and 3d. Although this arrangement extends the wiring distance between the clock gating circuit 1d and respective flip-flop circuits 2d and 3d, it is sufficient to provide only one buffer circuit for wave-shaping of a clock signal from the clock generator 1a in series with the clock gating circuit 1d.

That is, as shown in FIG. 1D which shows a circuit configuration after layout, it is only necessary to insert only one buffer circuit 1e between the clock gating circuit 1d and a common line connected between the respective flip-flop circuits 2d and 3d. The above circuit optimization allows the number of wave-shaping buffer circuits to be added at layout time to be reduced to one, thereby simplifying the circuit configuration and reducing power consumption.

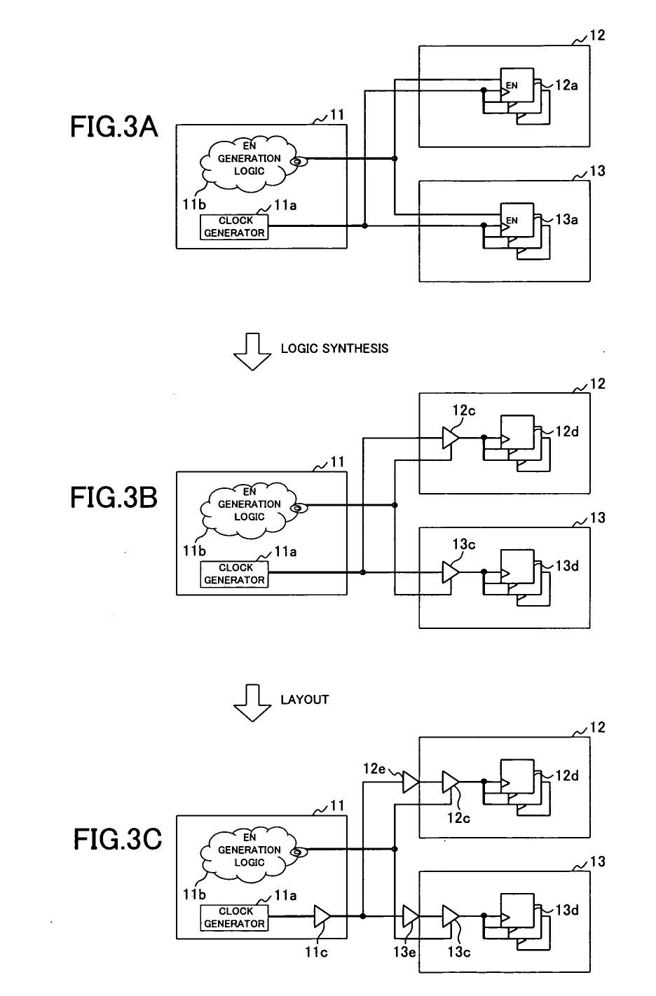

As described above, when the circuit design apparatus according to the present invention is used to rewrite RTL of a design target and perform the insertion of the clock gate logic and reorganization of logical hierarchies to thereby apply logic synthesis to the logic circuit after design change, the logic circuit is mapped on a circuit configuration with only one clock gating circuit 1d and one buffer circuit 1e. Consequently, as can be seen from a comparison between the circuit configuration after layout according to the present invention (FIG. 1D) and circuit configuration after layout according to the prior art (FIG. 3C), the numbers of clock gating circuits and buffer circuits are significantly reduced in the present invention. Thus, a circuit simplification and reduction of power consumption can be realized.

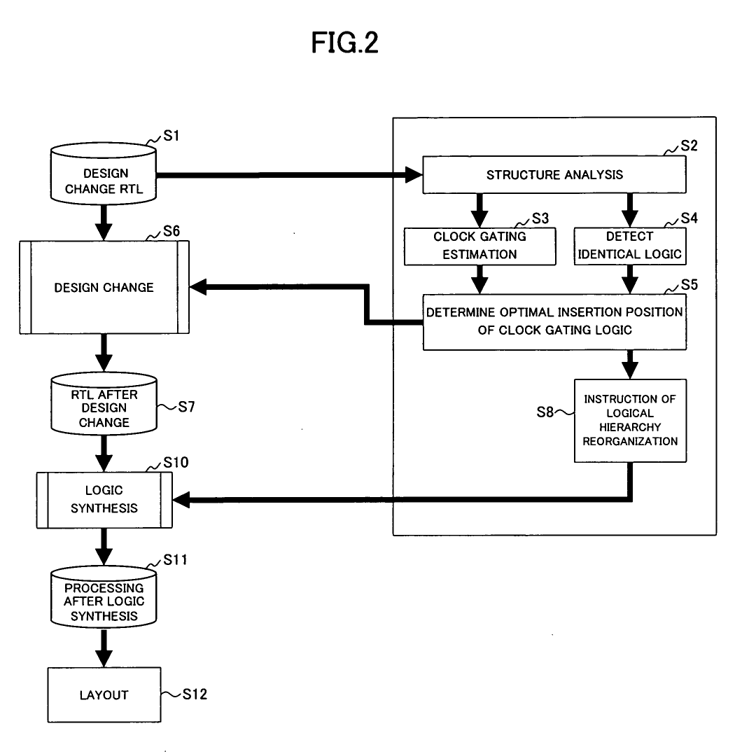

Next, a design flow of the circuit design apparatus according to the present invention will be described with reference to a flowchart. FIG. 2 is a flowchart showing the design flow of the circuit design apparatus for LSI to which the present invention has been applied.

Firstly, the circuit design apparatus acquires circuit information (i.e., a logic configuration at logic design stage as shown in FIG. 1A) described in RTL of a design target, which has been input by a user (step S1). The circuit design apparatus then interprets HDL (hardware description language) written in RTL and performs structure analysis of the input circuit information (step S2).

The circuit design apparatus then estimates, based on a result of the structure analysis, generation of clock gating circuits resulting from the logic synthesis, detects RTL description of the EN generation logic that controls the estimated clock gating circuit, and detects logical hierarchies to which the estimated clock gating circuits belong and logical hierarchies to which the detected EN generation logic belongs (Step S3). Further, the circuit design apparatus detects identical EN generation logic based on the structure analysis result and detects flip-flop circuits using the identical EN generation logic (step S4).

The circuit design apparatus then determines an optimal insertion location of the clock gating circuit based on the detected EN generation logic as well as logical hierarchies to be developed and creates insertion location information of the clock gate logic and logical hierarchy reorganization information based on the determination result (step S5). For example, the insertion location of the clock gating circuit 1d is searched by collecting, among the clock gating circuits whose generations have been estimated in step S3, all the circuits to be subjected to gating control by the identical EN generation logic which have been detected in step S4 and tracing the circuits toward a clock signal source of the clock generator 1a. Subsequently, the circuit design apparatus determines a logical hierarchy of the circuit to be subjected to gating control by the identical EN generation logic which have been detected in step S4 as the logical hierarchy to be developed.

In step S5, the logical hierarchy to be developed is determined. However, reorganization of logical hierarchy including development or creation of logical hierarchy according to the circuit function may also be determined in step S5.

The circuit design apparatus then performs design change processing for the circuit information of step S1 described in RTL of a design target using the insertion location information of the clock gate logic and reorganization information of logical hierarchy which are determined in step S5 (Step S6) and performs RTL description after design change to add the clock gate logic 1c, like the logic configuration after logic design change shown in FIG. 1B (step S7). In the design change processing of step S6, the circuit information described in RTL related to the insertion of a clock gate logic or reorganization of logical hierarchy is automatically rewritten.

After determination of the logical hierarchy to be developed in step S5, the circuit design apparatus creates a logical hierarchy reorganization instruction card for instructing reorganization of logical hierarchy at logic synthesis time (step S8). The logical hierarchy reorganization instruction card is a card in which the instruction of logical hierarchy reorganization has been described using a logical synthesis tool command.

The circuit design apparatus then uses the RTL description after design change of step S7 and logical hierarchy reorganization instruction card of step S8 to perform logic synthesis while reorganizing logical hierarchy. More specifically, the logic synthesis tool develops a logical hierarchy according to an instruction of the logical hierarchy reorganization instruction card to perform mapping to thereby obtaining the circuit configuration after logic synthesis as shown in FIG. 1C (step S10).

Through the logic synthesis that has been performed as described above, the circuit described in RTL (i.e., circuit configuration after logic synthesis shown in FIG. 1C) is converted into a technology-dependent net list and, in the net list after logic synthesis, logic optimization or development of logical hierarchies is performed (step S11). Then, layout processing is performed by a layout tool. As a result, the circuit configuration after layout is generated (step S12).

Although the design change processing including the insertion of a clock gate logic and reorganization of logical hierarchies is performed automatically in step S6, the design change processing may be performed manually by a user. In this case, in step S5, after determining the optimal insertion location of a clock gating circuit based on the clock gate logic and determining the logical hierarchies to be developed, the circuit design apparatus creates a clock gate logic insertion instruction report and a logical hierarchy reorganization instruction report and, in step S6, the user performs design change manually based on information of the clock gate logic insertion instruction report and logical hierarchy reorganization instruction report.

As described above in detail, the circuit design apparatus according to the present invention is a circuit design apparatus having a processing function of performing structure analysis of circuit design data targeted for a logic circuit described in a hardware description language and includes: a function that applies logic synthesis to a logic circuit to estimate mapping thereof to a buffer with gating logic; a function that detects an EN generation logic group that controls a gating logic according to an identical logical formula; a function that determines whether it is possible to reduce the number of buffers with gating logic by circuit optimization obtained by development of logical hierarchies; and a function that determines an optimal logical hierarchy in which the buffer with gating logic is inserted.

Thus, according to the present invention having the above functions, it is possible to remove the framework of logical hierarchy and share the EN generation logic. Therefore, when the logic synthesis is performed to map the logical circuit onto a concrete circuit configuration, the number of clock gating circuits for controlling a clock signal to be supplied to a flip-flop circuit or the number of buffer circuits for shaping the wave of a clock signal can be reduced. As a result, a reduction of power consumption as well as circuit simplification can be realized.

Further, according to the present invention, design change of the logic circuit for allowing a reduction of power consumption can not only automatically be performed based on the information output from the circuit design apparatus and, further, but also manually be performed by a user based on a report output from the circuit design apparatus. This configuration makes the circuit design apparatus that supports logic design of an LSI so that power consumption is reduced user-friendly.

Further, according to the present invention, it is possible to provide a circuit design method for realizing circuit optimization by properly supporting the development of the logical hierarchy using the circuit design apparatus and insertion location of the buffer with clock gate logic in the case where circuit design change is performed in order to reduce power consumption so that the number of buffers with clock gating logic is reduced.

Although the circuit design apparatus for an LSI has been described as a preferred example in the above embodiment, the present invention is not limited to this and can also be applied to various circuit design apparatus such as a circuit design apparatus for a hybrid IC or discrete circuit easily.

Further, it is possible to provide a program that allows a computer constituting the circuit design apparatus to execute the above steps as a circuit design program. By storing the above program in a computer-readable storage medium, it is possible to allow the computer constituting the circuit design apparatus to execute the program. The computer-readable medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

A correspondence between elements in claims and above embodiment will be described. A generation circuit data detection section and logical hierarchy detection section executes a part of structure analysis (step S2 of FIG. 2), a part of clock gating estimation (step S3 of FIG. 2), and a part of identical logic detection (step S4 of FIG. 2) which are performed by the circuit design apparatus in the embodiment.

A circuit design data correction instruction section executes processing of optimal clock gate logic insertion location determination (step S5 of FIG. 2) performed by the circuit design apparatus in the embodiment. The circuit design data correction section executes processing of design change (step S6 of FIG. 2). A logic synthesis section executes processing of logic synthesis (step S10 of FIG. 2).

What is claimed is:

1. A circuit design apparatus that makes correction of circuit design data for use in performing circuit design using logic synthesis, comprising:
a generation circuit data detection section that detects, based on the circuit design data, a first data portion in which a first clock gating circuit is estimated to be generated and a second data portion in which a control circuit that controls the first clock gating circuit is estimated to be generated;
a logical hierarchy detection section that detects logical hierarchies of the first clock gating circuit and the control circuit, generations of which are estimated by the generation circuit data detection section; and
a circuit design data correction instruction section that instructs reorganization of logical hierarchies in the circuit design data so that the number of logical hierarchies of the first clock gating circuit detected by the logical hierarchy detection section is reduced.

2. The circuit design apparatus according to claim 1, wherein
the circuit design data correction instruction section instructs insertion of a second clock gating circuit in the same logical hierarchy as the control circuit whose generation is estimated by the generation circuit data detection section.

3. The circuit design apparatus according to claim 1, wherein
in the case where a plurality of first clock gating circuits controlled by one control circuit whose generation is estimated by the generation circuit data detection section are estimated to be generated in a plurality of logical hierarchies, the circuit design data correction instruction section instructs correction of the circuit design data so that the plurality of logical hierarchies are developed.

4. The circuit design apparatus according to claim 1, further comprising:
a circuit design data correction section that performs reorganization of logical hierarchies and insertion of the second clock gating circuit for the circuit design data based on an instruction from the circuit design data correction instruction section.

5. The circuit design apparatus according to claim 4, further comprising:
a logic synthesis section that performs logic synthesis of circuit design data corrected by the circuit design data correction section.

6. A circuit design program allowing a computer to make correction of circuit design data for use in performing circuit design using logic synthesis, the program allowing the computer to execute:
a generation circuit data detection step that detects, based on the circuit design data, a first data portion in which a first clock gating circuit is estimated to be generated and a second data portion in which a control circuit that controls the first clock gating circuit is estimated to be generated;
a logical hierarchy detection step that detects logical hierarchies of the first clock gating circuit and the control circuit, generations of which are estimated by the generation circuit data detection step; and
a circuit design data correction instruction step that instructs reorganization of logical hierarchies in the circuit design data so that the number of logical hierarchies of the first clock gating circuit detected by the logical hierarchy detection step is reduced.

7. The circuit design program according to claim 6, wherein
the circuit design data correction instruction step instructs insertion of a second clock gating circuit in the same logical hierarchy as the control circuit whose generation is estimated by the generation circuit data detection step.

8. The circuit design program according to claim 6, wherein
in the case where a plurality of first clock gating circuits controlled by one control circuit whose generation is estimated by the generation circuit data detection step are estimated to be generated in a plurality of logical hierarchies, the circuit design data correction instruction step instructs correction of the circuit design data so that the plurality of logical hierarchies are developed.

9. The circuit design program according to claim 6, further allowing the computer to execute, after the circuit design data correction instruction step, a circuit design data correction step that performs reorganization of logical hierarchies and insertion of the second clock gating circuit for the circuit design data based on an instruction from the circuit design data correction instruction step.

10. The circuit design program according to claim 9, further allowing the computer to execute, after the circuit design data correction step, a logic synthesis step that performs logic synthesis of circuit design data corrected by the circuit design data correction step.

11. A circuit design method that makes correction of circuit design data for use in performing circuit design using logic synthesis, comprising:
a generation circuit data detection step that detects, based on the circuit design data, a first data portion in which a first clock gating circuit is estimated to be generated and a second data portion in which a control circuit that controls the first clock gating circuit is estimated to be generated;
a logical hierarchy detection step that detects logical hierarchies of the first clock gating circuit and the control circuit, generations of which are estimated by the generation circuit data detection step; and
a circuit design data correction instruction step that instructs reorganization of logical hierarchies in the circuit design data so that the number of logical hierarchies of the first clock gating circuit detected by the logical hierarchy detection step is reduced.

12. The circuit design method according to claim 11, wherein
the circuit design data correction instruction step instructs insertion of a second clock gating circuit in the same logical hierarchy as the control circuit whose generation is estimated by the generation circuit data detection step.

13. The circuit design method according to claim 11, wherein
in the case where a plurality of first clock gating circuits controlled by one control circuit whose generation is estimated by the generation circuit data detection step are estimated to be generated in a plurality of logical hierarchies, the circuit design data correction instruction step instructs correction of the circuit design data so that the plurality of logical hierarchies are developed.

14. The circuit design method according to claim 11, further comprising, after the circuit design data correction instruction step, a circuit design data correction step that performs reorganization of logical hierarchies and insertion of the second clock gating circuit for the circuit design data based on an instruction from the circuit design data correction instruction step.

15. The circuit design method according to claim 14, further comprising, after the circuit design data correction step, a logic synthesis step that performs logic synthesis of circuit design data corrected by the circuit design data correction step.
